(19) United States
(12) Patent Application Publication
(10) Pub. No.: US 2011/0073229 A1
(43) Pub. Date: Mar. 31, 2011

(54) LIGNIN IN TIRE COMPONENTS

(76) Inventors: Claudina Veas, Travelers Rest, SC (US); Elizabeth L. Hotaling, Piedmont, SC (US)

(21) Appl. No.: 12/995,167

(22) PCT Filed: May 30, 2008
(86) PCT No.: PCT/US08/65331

§ 371 Date: Nov. 29, 2010

(51) Int. Cl. B60C 11/00; B60C 13/00

(52) U.S. Cl. 152/209.1; 152/525

(57) ABSTRACT

A vehicle tire having a sidewall and an undertread, the sidewall, the undertread or both being based upon a rubber composition, the rubber composition comprising a highly unsaturated diene elastomer, a carcass grade carbon black and particles comprising at least 70 wt. % unsulfonated lignin, wherein the particles make up no more than 50 wt. % of the total weight of the particles and the carbon black.

### BACKGROUND OF THE INVENTION

1. Field of the Invention

This invention relates generally to tire components and more specifically, to tire components containing lignin.

2. Description of the Related Art

Rubber compositions have progressed from the use of untreated natural rubber to the use of complex polymeric systems that are formulated with synthetic elastomeric polymers useful for such products as vehicle tires, vibration dampers and other elastomeric products. Early in the development of rubber products, compounders dispersed fillers into the elastomers to provide physical reinforcement and/or bulk to the rubber compositions. Carbon black was one of the first materials commonly used as a filler. Other materials may also used as fillers, some for reinforcement, some to provide bulk and some for both, such materials including, for example, silica, clay and calcium carbonate. These and other fillers known in the art may be used alone or in combination in rubber compositions.

While fillers are well known and provide unique benefits to the elastomer products in which they are contained, the search continues for new and less costly fillers that can satisfy the consumer needs for these products. The tire industry especially searches for ways to satisfy the demand for ever-better vehicle tire performance at a lower cost.

### SUMMARY OF THE INVENTION

Particular embodiments of the present invention include a vehicle tire made of a material based upon a rubber composition containing particles of an unsulfonated lignin. The term “based upon’ as used herein recognizes that the rubber articles or rubber components are made of vulcanized or cured rubber compositions that were, at the time of their assembly, uncured. The cured rubber composition is therefore “based upon” the uncured rubber composition.

Particular components of tires that may be formed of the composition containing the unsulfonated lignin particles include either the sidewall of a vehicle tire, the undertread of a vehicle tire or both. Embodiments include, therefore, a vehicle tire having a sidewall and an undertread, the sidewall, the undertread or both being based upon a rubber composition, the rubber composition comprising a highly unsaturated diene elastomer, a carcass grade carbon black and particles comprising at least 70 wt. % unsulfonated lignin, wherein the particles make up no more than 50 wt. % of the total weight of the particles and the carbon black.

Another embodiment of the present invention includes a tread band for retreading a tire, the tread band having a cap portion and an undertread portion, the undertread portion based up a rubber composition comprising a highly unsaturated diene elastomer, a carcass grade carbon black and particles comprising at least 70 wt. % unsulfonated lignin, wherein the particles are no more than 50 wt. % of the total weight of the particles and the carbon black.

The foregoing and other objects, features and advantages of the invention will be apparent from the following more detailed descriptions of particular embodiments of the invention.

### DETAILED DESCRIPTION OF PARTICULAR EMBODIMENTS

A vehicle tire is made up of a number of parts or components, each of which has a specific function to perform in the tire. Typically a tire includes a pair of beads in the form of hoops for anchoring the ply and for providing a means for locking the tire onto the wheel assembly. The ply, extending from bead to bead, is comprised of cords that serve as the primary reinforcing material in the tire casing. The tire further includes belts extending circumferentially around the tire under the tread for stiffening the casing and the tread. The tread is that portion of the tire that contacts the road or other driving surface. The sidewall of the tire protects the ply or plies from road hazards and ozone and is typically the outermost rubber component of the tire extending between the tread and the bead.

Some tire treads are of a cap/undertread construction, with the cap designed to be ground-contacting with an outer surface configured with lugs and grooves and with the undertread designed to be underlying and supporting the cap. The undertread is therefore positioned between the tread cap and the tire carcass. The undertread is not intended to be ground-contacting and therefore is not intended to have the same properties as the cap, e.g., good traction and good treadwear.

Embodiments of the present invention include rubber compositions and articles made with the rubber compositions, the rubber compositions having particles comprising at least 70 wt. % unsulfonated lignin as a filler. Embodiments of the present invention include vehicle tires having sidewalls and/or undertread made of the rubber composition having the lignin-containing particles. Vehicle tires may include, for example, passenger tires, light truck tires, truck tires, off-the-road tires and aircraft tires.

Lignin is a complex high-molecular weight polymer, phenolic in nature, occurring naturally in close association with cellulose in plants and trees. Lignin is the second most abundant class of chemicals found in wood, with cellulose being the most abundant chemical. The unsulfonated lignin useful in particular embodiments of the present invention is recovered from the black liquor (comprising NaOH and Na₂S) used to disolve the lignin and thereby separate it from the cellulose during the kraft pulping operation.

In particular embodiments, the recovered lignin product is spray dried to provide a free-flowing powder. Since the cellulose fibers have been removed during the pulping process, the lignin particles are essentially fiber-free particles. An example of a suitable lignin is INDULIN AT, a kraft pine lignin in the form of a free-flowing powder having a lignin content of 97 wt. % and available from MeadWestvaco Corporation.

Particular embodiments of the present invention include rubber compositions and articles made therefrom that have lignin particles having at least 70 wt. % unsulfonated lignin or in other embodiments, at least 80 wt. %, at least 90 wt. %, at least 95 wt. % or at least 97 wt. % unsulfonated lignin The lignin is typically purified by removing salts that are trapped in the lignin during the recovery process. Particular embodiments may further limit the lignin to unsulfonated lignin from soft wood sources, such as pine. The unsulfonated lignin from softwood sources may be further limited to include only those that are insoluble in water and have not been sulfomethylated, a process that makes such ligin water soluble.

Particular embodiments of the composition useful for rubber articles, including sidewalls and undertread of vehicle tires, may include in addition to the particles containing unsulfonated lignin, a highly unsaturated diene elastomer and a carcass grade carbon black.

Diene elastomers or rubber is understood to mean those elastomers resulting at least in part (i.e., a homopolymer or a copolymer) from diene monomers (monomers bearing two double carbon-carbon bonds, whether conjugated or not). Essentially unsaturated diene elastomers are understood to mean those diene elastomers that result at least in part from conjugated diene monomers, having a content of members or units of diene origin (conjugated dienes) that are greater than 15 mol. %.

Thus, for example, diene elastomers such as butyl rubbers, nitrile rubbers or copolymers of dienes and of alpha-olefins of the ethylene-propylene diene terpolymer (EPDM) type or the ethylene-vinyl acetate copolymer type do not fall within the preceding definition, and may in particular be described as “essentially saturated” diene elastomers (low or very low content of units of diene origin, i.e., less than 15 mol. %). Particular embodiments of the present invention include no essentially saturated diene elastomers.

Within the category of essentially unsaturated diene elastomers are the highly unsaturated diene elastomers, which are understood to mean in particular diene elastomers having a content of units of diene origin (conjugated dienes) that is greater than 50 mol. %. Particular embodiments of the present invention may include not only no essentially saturated diene elastomers but also no essentially unsaturated diene elastomers that are not highly unsaturated.

The rubber elastomers suitable for use with particular embodiments of the present invention include highly unsaturated diene elastomers, for example, polybutadienes (BR), polyisoprenes (IR), natural rubber (NR), butadiene copolymers, isoprene copolymers and mixtures of these elastomers.

Also suitable for use in particular embodiments of the present invention are rubber elastomers that are copolymers and include, for example, butadiene-styrene copolymers (SBR), butadiene-isoprene copolymers (BIR), isoprene-styrene copolymers (SIR) and isoprene-butadiene-styrene copolymers (SBIR), mixtures thereof and/or with other essentially unsaturated and/or highly unsaturated rubber elastomers.

Also suitable for use in particular embodiments of the present invention are rubber elastomers that include, for example, natural rubber, synthetic cis-1,4 polyisoprenes and mixtures thereof and/or with other essentially unsaturated and/or highly unsaturated rubber elastomers. These synthetic cis-1,4 polyisoprenes may be characterized as possessing cis-1,4 bonds at more than 90 mol. % or alternatively, at more than 98 mol. %.

It should be noted that any of the essentially unsaturated and/or highly unsaturated elastomers may be utilized in particular embodiments as a functionalized elastomer. These elastomers can be functionalized by reacting them with suitable functionalizing agents prior to or in lieu of terminating the elastomer. Exemplary functionalizing agents include, but are not limited to, metal halides, metalloid halides, alkoxysilanes, imine-containing compounds, esters, ester-carboxylate metal complexes, alkyl ester carboxylate metal complexes, aldehydes or ketones, amides, isocyanates, isothiocyanates, imines, and epoxides. These types of functionalized elastomers are known to those of ordinary skill in the art. While particular embodiments may include one or more of these functionalized elastomers, other embodiments may include one or more of these functionalized elastomers mixed with one or more of the non-functionalized essentially unsaturated and/or highly unsaturated elastomers.

A carcass grade carbon black is also included in particular embodiments of the rubber composition disclosed herein. Carbon blacks are widely used as pigments, fillers and reinforcing agents in the compounding and preparation of rubber and other elastomeric compounds. These materials are particularly useful as reinforcing agents in the preparation of elastomeric compounds used in the manufacture of tires.

Two general categories of carbon blacks used in the tire industry are tread grade carbon blacks and carcass grade carbon blacks. Carbon blacks are classified according to a standard classification system provided under ASTM designation D1765. In accordance with this standard, rubber grade carbon blacks are classified using a four-character nomenclature: the first character gives an indication of the influence of the carbon black on the rate of cure of a typical rubber compound containing the carbon black; the second character, the group number, gives information on the average surface area of the carbon black and the last two characters are assigned arbitrarily. Thus, for example, an N347 carbon back describes, with the “N,” a carbon black that has a normal effect on the cure rate and, with the group number “3,” indicates a carbon black having an average nitrogen surface area of between 70 and 99 m²/g. Carbon blacks in the ASTM N 100-N300 series are considered to be tread grade carbon blacks while the carbon blacks having the larger particles in the ASTM N500-N900 series are considered to be carcass grade carbon blacks.

Particular embodiments of the present invention include rubber compositions and articles made therefrom having a mixture of carcass grade carbon black and unsulfonated lignin particles as the filler for the rubber composition. Advantageously, the unsulfonated lignin can replace at least a part of the carcass grade carbon black in a rubber composition while still maintaining desirable physical properties. In particular embodiments, the unsulfonated lignin particles make up no more than 50 wt. % of the total mixture of the unsulfonated lignin particles and the carcass grade carbon black. In other embodiments, the lignin particles make up no more than 40 wt. %, 20 wt. % or 10 wt. % of the total weight of the unsulfonated lignin particles and the carbon black.

Particular embodiments of the present invention may further include within an uncured rubber elastomer composition other components such as, for example, coupling agents, plasticizers, antiozonants, resins, various processing aids, oil extenders, surfactants, antioxidants, curing agents, curing accelerators or combinations thereof as known to those having ordinary skill in the art.

Particular embodiments of the present invention also include tread bands suitable for use in retreading tires. A variety of procedures and different types of equipment are available for use in recapping or retreading pneumatic tires. One of the first steps in retreading a worn tire is to remove remaining tread material from the tire carcass, for example, by a sanding procedure known as buffing. Next a layer of green (uncured) rubber, the cushion gum, is applied to the carcass. This layer of extruded uncured rubber may be stitched or adhesively bonded to the carcass. Next, a tread band is applied atop the layer of cushion gum. The tread band may be formed of a cap layer and an undertread layer, the undertread layer being made of the lignin-containing rubber composition disclosed herein.

The tire is then placed in an autoclave, and heated under pressure for an appropriate time to induce curing of the cushion gum layer, and bonding of the cushion gum layer to the tread and the carcass. In the hot recapping process, the tread is uncured rubber, and has no tread pattern. The tire is then placed in a tire mold and heated under pressure for an appropriate time to cure the gum layer and the tread, and to cause the gum layer to bind with the tread and the carcass. The term “cure” refers to the formation of cross-links between the elastomer molecules in the rubber compound, otherwise known as vulcanization.

The invention is further illustrated by the following examples, which are to be regarded only as illustrations and not delimitative of the invention in any way. The properties of the compositions disclosed in the examples were evaluated as described below.

Moduli of elongation (MPa) were measured at 10%, 100% and at 300% at a temperature of 23° C. based on ASTM Standard D412 on dumb bell test pieces. These measurements are secant moduli in MPa, based on the original cross section of the test piece. Some test pieces were aged in a circulating oven at 77° C. for 15 days before being tested.

Hysteresis losses (HL) were measured in percent by rebound at 60° C. at the sixth impact in accordance with the following equation:

HL(%)=100(W₀−W₁)/W₁,

where W₀ is the energy supplied and W₁ is the energy restored. Some test pieces were aged in a non-circulating oven at 77° C. for 8 or 15 days before being tested.

The elongation property was measured as elongation at break (%) and the corresponding elongation stress (MPa), which is measured at 23° C. based on ASTM Standard D412 on dumb bell test pieces.

Dynamic Properties: The dynamic characteristics of the materials are measured on an MTS 831 Elastomer Test System in accordance with ASTM D5992. The response of a sample of vulcanized material (cylindrical test piece of a thickness of 4 mm and a section of 400 mm²), subjected to an alternation single sinusoidal shearing stress, at a frequency of 10 Hz and at 80° C., is recorded. Scanning is effected at an amplitude of deformation of 0.1 to 50% (outward cycle), then of 50% to 0.1% (return cycle). The shear modulus G* at 10% deformation in MPa and the maximum value of the tangent of the loss angle tan delta (max tan δ) is determined during the return cycle.

Ozone resistance to surface cracking was evaluated using a test closely related to the ASTM 1149-99 Standard Test Method for Rubber Deterioration entitled Surface ozone cracking in a chamber. The testing utilized in the examples that follow differs in the construction of the sample holder, which was a rod rather than a wooden block holder as required under the ASTM test method. Rectangular samples were cut with a die then folded in half and stapled such that the curvature of the loop has a maximum local strain of 18%.

These samples were hung on a rod for 2-5 days under ambient conditions before being placed in an ozone chamber. The ozone chamber conditions were set at 50 parts per hundred million ozone (pphm) and a temperature of 40° C. for three weeks. The samples were evaluated for cracks every week for three weeks. The samples were evaluated using the Rubber Deterioration Test Grades that consists of three numbers. The first number indicates the number of cracks in the sample, the second rates the width of the cracks and the third number is the depth of the crack. Zero indicates that no cracks were observed.

Cyclic fatigue testing was conducted on the cured test samples that were dumbbell shaped and 65 mm long. The test was conducted at ambient temperature by imposing cyclic strain from between 0% and 75% on the test pieces. The total number of cycles to failure was recorded for each test sample as the measurement of cyclic fatigue. Some test pieces were aged in a circulating oven at 77° C. for 15 days before being tested.

Tack or adhesive testing was conducted on the uncured (green) rubber compositions to determine their tack. A test sample was prepared by first placing 2 pieces of green rubber together. A circular area (20 mm diameter) of the sample was subjected to a force of 20 N for a set period of time. The time for the samples tested was 5 seconds and 16 seconds. The tack was measured as the force (N) required to separate the two pieces of green rubber as they were being pulled apart at a set speed of 100 mm/min.

### EXAMPLE 1

Several formulations of rubber compositions having the unsulfonated lignin were prepared with the materials shown in Table 1. Two witness formulations were also prepared without the unsulfonated lignin as shown in Table 1. Two thermochemical stages were used to prepare the rubber compositions. First, the elastomer, the lignin, the carbon black and all the other ingredients except for the curing agents were introduced into a Banbury-type mixer in the amounts shown in Table 1. This material was then mixed at a rotor speed of 55 RPM. The mixing was continued until the temperature reached 145° C. at which time the mixture was dropped and allowed to cool to about 50° C.

In the second stage, the cooled mixture was transferred to a mill having two cylinders that operated at a speed of 30 RPM. The vulcanizing agents were added and mixing continued until the vulcanizing agents were well dispersed, which was for up to about 8 minutes milling time.

The lignin was INDULIN AT, an unsulfonated lignin available from MeadWestvaco Corporation. The sulfur curing system included insoluble sulfur, accelerators and vulcanization actuators as known to one having ordinary skill in the art. The antidegradant package included antioxidants and antiozonants.

TABLE 1
Rubber Formulations and Physical Properties

| | W1 | F1 | F2 | F3 | W2 | F4 | F5 |
|---|---|---|---|---|---|---|---|
| Components | | | | | | | |
| Natural. Rubber | 35 | 35 | 35 | 35 | 100 | 100 | 100 |
| Butadiene Rubber | 65 | 65 | 65 | 65 | | | |
| N650 | 60 | 50 | 50 | 30 | | | |
| N772 | | | | | 45 | 25 | 25 |
| Unsulfonated Lignin | 0 | 10 | 10 | 30 | 0 | 20 | 30 |
| Surfactant | | 0 | 0.08 | 0.25 | | | |
| Tackifier | | | | | 5 | 5 | 5 |
| Aromatic Oil | 25 | 25 | 25 | 25 | | | |
| Antidegradants | 4.9 | 4.9 | 4.9 | 4.9 | 1 | 1 | 1 |
| Curing Package | 6.7 | 6.7 | 6.7 | 6.7 | 5.6 | 5.6 | 5.6 |
| Physical Properties | | | | | | | |
| Modulus 100% (MPa) | 1.49 | 1.30 | 1.28 | 2.25 | 2.06 | 1.80 | 1.88 |
| Modulus 300% (MPa) | 1.66 | 1.23 | 1.21 | 0.62 | 2.39 | 1.33 | 1.28 |
| Modulus 100%, aged 15 (MPa) | 2.30 | 2.23 | 2.18 | 1.66 | | | |
| Modulus 300%, aged 15 (MPa) | 2.48 | 2.13 | 2.10 | 1.20 | | | |
| Hysteresis Loss, % | 14.5 | 16.2 | 16.2 | 23.00 | 7.3 | 7.0 | 8.9 |
| Hysteresis Loss, % aged 8 | 15.3 | 14.8 | 14.7 | 14.8 | | | |
| Hysteresis Loss, % aged 15 | 16.6 | 15.8 | 15.4 | 16.1 | | | |
| Static Ozone | 0, 0, 0 | 0, 0, 0 | 0, 0, 0 | 0, 0, 0 | | | |
| Tan Delta, (10 Hz) | | | | | 0.0507 | 0.0389 | 0.0771 |
| Elongation at Break, % | 536 | 641 | 633 | 753 | 469 | 590 | 534 |
| Elong. Stress at Break (MPa) | 14.46 | 15.16 | 14.82 | 10.80 | 22.4 | 20.2 | 16.9 |
| Tack (N), 5 seconds | 3.76 | 3.80 | 4.41 | 6.13 | 94.3 | 101.2 | 102.9 |
| Tack (N), 16 seconds | 5.91 | 6.07 | 6.29 | 8.12 | 104.4 | 110.8 | 114.3 |

Each of the formulations were rolled into sheets and then cured for 15 minutes 150° C. The sheets were then cut into test pieces for testing according to the test methods described above. The results are shown in Table 1 as the physical properties of the formulations.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention. Ranges that are described as being “between a and b” are inclusive of the values for “a” and “b.”

It should be understood from the foregoing description that various modifications and changes may be made to the embodiments of the present invention without departing from its true spirit. The foregoing description is provided for the purpose of illustration only and should not be construed in a limiting sense. Only the language of the following claims should limit the scope of this invention.

What is claimed is:

1. A vehicle tire having an undertread, the undertread being based upon a rubber composition, the rubber composition comprising:
a highly unsaturated diene elastomer;
a carcass grade carbon black; and
particles comprising at least 70 wt. % unsulfonated lignin, wherein the particles make up no more than 50 wt. % of the total weight of the particles and the carbon black.

2. The vehicle tire of claim 1, wherein the particles are no more than 40 wt. % of the total weight of the particles and the carbon black.

3. The vehicle tire of claim 1, wherein the particles are no more than 20 wt. % of the total weight of the particles and the carbon black.

4. The vehicle tire of claim 1, wherein the particles are no more than 10 wt. % of the total weight of the particles and the carbon black.

5. The vehicle tire of claim 1, wherein the unsulfonated lignin particles are a spray dried powder.

6. The vehicle tire of claim 1, wherein the particles comprise at least 90 wt. % unsulfonated

7. The vehicle tire of claim 1, wherein the particles comprise at least 97 wt. % unsulfonated lignin.

8. The vehicle tire of claim 1, wherein the particles are essentially free of fibers.

9. The vehicle tire of claim 1, wherein the unsulfonated lignin is water insoluble.

10. The vehicle tire of claim 1, wherein the diene elastomer is selected from polybutadienes, polyisoprenes, natural rubber, butadiene copolymers, isoprene copolymers or mixtures thereof.

11. The vehicle tire of claim 1, wherein the diene elastomer is selected from butadiene-styrene copolymers, butadiene-isoprene copolymers, isoprene-styrene copolymers and isoprene-butadiene-styrene copolymers.

12. The vehicle tire of claim 1, wherein the vehicle tire is a passenger tire.

13. The vehicle tire of claim 1, wherein the carbon black is classified as an N600 series or N700 series carbon black.

14. A vehicle tire having a sidewall, the sidewall being based upon a rubber composition, the rubber composition comprising:
a highly unsaturated diene elastomer;
a carcass grade carbon black; and
particles comprising at least 70 wt. % unsulfonated lignin, wherein the particles make up no more than 50 wt. % of the total weight of the particles and the carbon black.

15. The vehicle tire of claim 14, wherein the particles are no more than 20 wt. % of the total weight of the particles and the carbon black.

16. The vehicle tire of claim 14, wherein the particles are no more than 10 wt. % of the total weight of the particles and the carbon black.

17. The vehicle tire of claim 14, wherein the particles comprise at least 97 wt. % unsulfonated lignin.

18. A tread band for retreading a tire, the tread band having a cap portion and an undertread portion, the undertread portion being based upon a rubber composition comprising:
a highly unsaturated diene elastomer;
a carcass grade carbon black; and
particles comprising at least 70 wt. % unsulfonated lignin, wherein the particles make up no more than 50 wt. % of the total weight of the particles and the carbon black.

19. The tread band of claim 18, wherein the particles are no more than 10 wt. % of the total weight of the particles and the carbon black.

20. The tread band of claim 18, wherein the particles comprise at least 97 wt. % unsulfonated lignin.
